(19) United States
(12) Patent Application Publication
(10) Pub. No.: US 2004/0223423 A1
(43) Pub. Date: Nov. 11, 2004

(54) Optical pick-up actuator and method for assembling an optical pick-up actuator

(76) Inventor: Shiro Tsuda, Asahl (JP)

Correspondence Address: MESMER & DELEAULT, PLLC, 41 BROOK STREET, MANCHESTER, NH, 03104, US

(21) Appl. No.: 10/869,125

(22) Filed: Jun. 16, 2004

Related U.S. Application Data
(63) Continuation-in-part of application No. 10/172,961, filed on Jun. 17, 2002.
Application No. 10/172,961 is a continuation-in-part of application No. 10/121,129, filed on Apr. 11, 2002.

(51) Int. Cl. G11B 7/00

(52) U.S. Cl. 369/44.16

(57) ABSTRACT

The method of assembling a pick-up actuator includes assembling a lens holder assembly to a base unit creating a magnetic gap between complementary electromagnetic components of the lens holder assembly and the base unit, disposing a quantity of a volatile magnetic fluid or a low viscosity oil-based magnetic fluid into the magnetic gap created between complementary electro-magnetic components of a lens holder assembly and a base unit, fixing resilient support members between the lens holder assembly and the base unit. The optical pick-up actuator includes a lens holder assembly, a base unit, resilient support members connecting the lens holder assembly and the base unit, an electromagnetic drive system, and a volatile magnetic fluid or a low viscosity oil-based magnetic fluid.

This application is a continuation-in-part application of Ser. No. 10/172,961, filed on Jun. 17, 2002, which is a continuation-in-part application of Ser. No. 10/121,129, filed on Apr. 11, 2002.

### BACKGROUND OF THE INVENTION

1. Field of the Invention

The present invention relates generally to an apparatus and method for optical pickup actuators. Particularly, this invention relates to an optical pick-up actuator and a method of assembling optical pick-up actuator using a liquid centering mechanism.

2. Description of the Related Art

Conventional optical pickup actuators commonly include an optical lens focusing an optical spot of an optical beam at the center of a signal track of an optical disc. The optical pick-up actuator operates in order to make the optical lens perform a focusing and a tracking function. The focusing function involves moving the optical lens up and down in order to place an optical spot of an optical beam of the optical lens within a depth of focus on a signal track of an optical disc. The tracking function involves moving the optical lens right and left in order to cause the optical spot of the optical beam of the optical lens to follow the center of the signal track. Hence, the optical pick-up actuator follows the center of the signal track of the optical disk by moving the optical lens up/down and right/left.

To achieve this up/down and right/left movement, conventional optical pick-up units use current flow through a coil and a magnetic field between magnets. Generally, the optical pick-up actuator has a base unit and a lens holder resiliently attached to the base unit. The lens holder includes an objective lens mounted thereto, at least one opening in the lens holder, resilient support members attached on one end to opposite sides of the lens holder and on the other end to the base unit, a focusing coil attached to the lens holder and wound parallel to the plane of the lens holder, and a tracking coil perpendicular to the focusing coil. A pair of magnets and yokes is attached to the base unit in close proximity to the focusing coil and tracking coil creating a magnetic gap between the magnets and the lens holder. The yokes are incorporated to prevent leakage of magnetic flux from the rear of the magnets. Controlling the current through the focusing and tracking coils causes the optical holder to move up/down and right/left as required for proper focusing of the laser beam and tracking of the optical disc.

As with most electronic components, the trend in optical pick-up actuators is to make the optical pick-up system thinner and smaller. To achieve improvements in the optical pick-up system size, various reconfigurations have been proposed. For example, the optical lens and lens holder design were re-configured to move the optical lens from a central position in the lens holder to a protrusion portion and to move the focusing and tracking coils and the magnets from the periphery of the lens holder to the center of the lens holder. However, this configuration causes the fixation point of the resilient members to be spaced from the protrusion portion containing the optical lens. Hence, in high speed mode, unstable movement can occur. Because the optical lens is located on a protrusion of the lens holder away from the lens holder center, resonance and vibration of the optical lens becomes more pronounce.

Where increased accuracy of the optical pick-up actuator along with the reduction in size is also continually required, the optical tilt permissive error of the previously mentioned configuration becomes impossible to achieve with conventional assembly methods. One solution was to provide an optical pick-up actuator capable of performing a radial tilt movement with a focusing and tracking movement. This was accomplished by placing the focusing/tilt magnetic circuit at the center portion of the lens holder and placing the tracking magnetic circuit at the right and left portions of the lens holder. U.S. Pat. No. 6,744,722 (2004, Choi) is an example of such a device.

Other prior art devices have attempted to solve the vibration problem by using a damping material. U.S. Pat. No. 6,330,120 (2001, Shibusaka et al.) discloses an actuator for objective lenses that includes a resilient support member between a lens holder and a base member to resiliently support the lens holder with respect to the base member. A pair of auxiliary damping members extends along the length of the resilient support member. A viscoelastic material piece is provided between the two auxiliary damping members so as to connect them to each other.

U.S. Pat. No. 6,091,553 (2000, Song et al.) discloses a pick-up actuator. The pick-up actuator has a base member, a pair of yokes disposed at the base member and spaced from each other at a predetermined distance, a pair of magnets respectively attached to the inner side surfaces of the yokes, a lens holder which is suspended by two pairs of wire springs so as to be moved toward directions of focusing and tracking in a space defined between the magnets, and on which an objective lens is mounted, a driving coil disposed at the lens holder for driving the lens holder toward directions of focusing and tracking by electromagnetically interacting with the magnets, a pair of supporting plates disposed on the wire springs adjacent to opposite sides of one of the magnets, and a damping fluid applied between the pair of supporting plates and both opposite side portions of the one magnet.

Japanese Patent No. 3,059,141 (2000, Shin Kyung-sik) discloses a pickup actuator that uses a high viscosity magnetic fluid as a damping fluid between a base member and the lens holder.

Manufacturers of optical pick-up actuators are also concerned with improving device performance. One factor that improves pick-up actuator performance is to narrow the magnetic gap between the focusing and tracking coils and the magnets. However, current manufacturing techniques limit the size of the magnetic gap, i.e. how narrow the magnetic gap can be made. This is due to the difficulty in properly centering the lens holder even when using centering fixtures because of the structure of the lens holder itself.

Therefore, what is needed is an assembly method that allows the optical pick-up actuator's lens holder to be easily centered and suspended during the manufacturing process. What is also needed is an assembly method that reduces the manufacturing process rejection rate. What is further needed is an assembly method that is inexpensive to use. What is still further needed is an assembly method that provides for improved damping of the optical pick-up actuator.

### SUMMARY OF THE INVENTION

It is an object of the present invention to provide an optical pick-up actuator and a method of manufacturing optical pick-up actuators that are inexpensive to implement. It is another object of the present invention to provide a method of manufacturing optical pick-up actuators that locates and properly spaces the optical lens holder with its complementary electromagnetic components of an electro-magnetic drive system from the complementary electromagnetic components of the base unit during the assembly of the optical pick-up actuator. It is a further object of the present invention to provide a system to enhance damping of vibration of an optical pick-up actuator. It is still another object of the present invention to provide to an improved heat transfer capacity from the focusing and tracking coils of an optical pick-up actuator.

The present invention achieves these and other objectives by providing a simple method and mechanism for locating and properly spacing the complementary components of an electromagnetic drive system of the optical lens holder relative to the base unit's complementary components of the electromagnetic drive system during the assembly process. The method includes the step of adding a predetermined amount of a magnetic fluid to the magnetic gap between the complementary components of the electro-magnetic drive system of the optical pick-up actuator. In one embodiment where the electromagnetic complementary components of the lens holder are the focusing and tracking coils, the magnetic fluid locates and properly spaces the lens holder and focusing/tracking coils in the magnetic gap relative to the magnets, which are the complementary electro-magnetic components on the base unit, during the assembly process. The resilient support members, which are attached at one end to the lens holder, are then fixed to the base unit. It should be understood by those skilled in the art that the drive system of the optical pick-up actuator may have the magnets fixed to the lens holder and the focusing/tracking coils fixed on the base unit.

The magnetic fluid may optionally be either a volatile magnetic fluid or a low viscosity oil-based magnetic fluid. Both types of magnetic fluid used in the present application are colloids comprising ultra fine magnetic particles of about 10 nanometers in diameter, at least one surfactant to modify the surface of the magnetic particles, and a dispersing media as the main ingredients. The magnetic fluid is liquid but has magnetism and can be positioned and held in place without a container.

In the embodiment using a volatile magnetic fluid, the volatile magnetic fluid is used only during the assembly process. Once the lens holder and resilient support members are fixed to the base unit or support structure of the optical pick-up actuator, the volatile portion of the magnetic fluid is evaporated leaving an air gap between the focusing/tracking coils and the yokes/magnets of the optical pick-up actuator. Upon evaporation of the volatile carrier liquid, the magnetic particles are deposited onto the yokes/magnets and the focusing/tracking coil surfaces. Lubricating oil may optionally be added to the volatile magnetic fluid. In this preferred embodiment, the lubricating oil remains behind upon evaporation of the volatile carrier liquid with the magnetic particles forming a thin layer of magnetic fluid over the magnets, yokes and coil surfaces.

An acceptable volatile magnetic fluid is one having a relatively volatile carrier base liquid with a relatively small amount of lubricating oil. The volatile carrier liquid typically is a volatile liquid that is capable of undergoing evaporation at room temperature or at elevated temperatures. Examples of useful volatile liquids are water and aliphatic hydrocarbon solvents such as octane, heptane and hexane. The lubricating oil is of a type and quantity such that upon evaporation of the volatile carrier liquid, the remaining magnetic particles and lubricating oil would form an oil-based magnetic fluid film or layer along the surfaces of the magnets, yokes and focusing/tracking coils. A light lubricating oil having a 4 cSt (centistoke) or lower viscosity at 100° C. is preferred. The types of oils that can be used as the light lubricating oil, for example, are hydrocarbon, ester, ether, perfluorocarbon, and silicone. Unlike oil-based carrier liquid magnetic fluids, the remaining magnetic fluid of the present invention does not require a high temperature capability. This is so because the focusing/tracking coils of the present invention is not in constant contact with the magnetic fluid.

Generally, the saturation magnetization is as low as possible for use as a lens holder and focusing/tracking coil positioning mechanism for a given optical pick-up actuator configuration so as not to form a thick residual layer of magnetic particles and lubricating oil on the magnetic surfaces. In addition, the volume percent of lubricating oil used in the volatile magnetic fluid is inversely proportional to the saturation magnetization of the remaining fluid after evaporation of the volatile carrier liquid. This is so because the lower the volume percent of the lubricating oil to the total volume of the volatile magnetic fluid plus the lubricating oil, the higher the concentration of magnetic particles to the volume of lubricating oil remaining after evaporation of the volatile carrier liquid. The range of the initial saturation magnetization of the volatile magnetic fluid and the amount of the lubricating oil used is application dependent. In other words, it is dependent on the type of optical pick-up actuator, the size of the magnetic gap, and the size of the focusing/tracking coils.

In the embodiment using a low viscosity oil-based magnetic fluid, the magnetic fluid typically uses a low volatile, relatively high molecular weight, oil-based carrier liquid such as an ester-based oil. These oil-based magnetic fluids are used to maintain the lens holder and focusing/tracking coils evenly spaced within the magnetic gap during assembly and as a damping and/or heat dissipating fluid during operation of the optical pick-up actuator. The reason the magnetic fluid is an oil-based magnetic fluid is to prevent the magnetic fluid from undergoing evaporation at room temperature or elevated temperature during and after the assembly process as well as during optical pick-up actuator use. It is a fundamental requirement of using oil-based magnetic fluids in optical pick-up actuators that the oil-based magnetic fluid stays within and fills the space, i.e. the radial gap, between the focusing/tracking coils and the magnetic yokes and magnets. Should the oil-based magnetic fluid evaporate, the magnetic fluid would congeal and cause the optical pick-up actuator to fail.

Oil-based carrier liquid magnetic fluids require a high temperature capability because the current flow through the focusing/tracking coils in the magnetic gap containing the magnetic fluid is a source of heat generation. Although the low viscosity oil-based magnetic fluid of the present invention requires a high temperature capability, it is preferable to use a magnetic fluid having a viscosity of less than 1,000 cP, preferably 500 cP or less, more preferably 300 cP or less at 27° C. The low viscosity oil-based magnetic fluid is applied to the magnetic gap of a conventional optical pick-up actuator between the magnet of the pick-up actuator and the coils, between the yoke and coils or between magnet and yoke with the coils located therebetween. A sufficient amount of the low viscosity oil-based magnetic fluid is used to contact with the coils but not so much that the magnetic fluid would splash out by a shocking or a vibrating operation applied to the above mentioned location of the optical pick-up actuator. The optimum filling amount of magnetic fluid depends on the design of the pick-up actuator.

The use of low viscosity oil-based magnetic fluid also provides an added damping benefit to the movement of the lens holder during focusing and tracking. The vibration in the lens holder arising from the focusing and tracking function is damped by the oil-based magnetic fluid that is present in the magnetic gap.

Where heat dissipation is also a concern, heat removal from the coils can be done more effectively with the use of the low viscosity oil-based magnetic fluid than without the use of magnetic fluid. This is so because the magnetic fluid is six times more thermally conductive than air. Thus, the transfer of heat from the coils through the magnetic fluid to the magnet and/or yoke is more effective than through air in the magnetic gap of conventional optical pick-up actuators. Using a thermally conductive material for the base unit to which the magnets and yokes are fixed further enhances heat dissipation. The yoke may also be configured as a base unit.

Further, unlike the high viscosity oil-based magnetic fluids used in the prior art, the sensitivity of an optical pick-up actuator using the low viscosity oil-based magnetic fluid of the present invention is unaffected when used at lower temperatures due to the low viscosity of the oil-based magnetic fluid of the present invention.

The preferred method of the present invention involves obtaining a volatile magnetic fluid and adding a predetermined amount of lubricating oil to the volatile magnetic fluid. The volatile magnetic fluid and lubricating oil mixture is then added to the magnetic gap of the optical pick-up actuator. The volatile magnetic fluid may be added using a dispenser or by dipping a solid needle rod or a hollow rod (i.e. capillary tube) into the magnetic fluid and locating the solid rod, the hollow rod or the dispenser close to the magnetic gap. The wetting ability of the ferrofluid and the magnetic force field of the magnets, yokes and coils cause the volatile magnetic fluid to fill the magnetic gap of the optical pick-up actuator. The lens holder of the optical pick-up actuator is then positioned relative to the magnets and yokes such that the coils of the lens holder are spaced from the magnets and/or yokes creating a magnetic gap. The volatile magnetic fluid will become disposed between the focusing/tracking coils and the magnets/yokes causing the lens holder to be positioned such that the magnetic gap created is evenly spaced between the coils and magnets/yokes.

The resilient support members extending from the lens holder can then be secured into position. Once secured, the volatile magnetic fluid is evaporated leaving a thin film/layer of lubricating oil containing magnetic particles disposed about the surface of the magnets and yokes and the focusing/tracking coils within the magnetic gap. The remaining mixture of lubricating oil and magnetic particles is itself a lower viscosity oil-based magnetic fluid. It has the characteristic of forming a thin film or layer along the surface of the magnets and yokes due to the magnetic force field, yet is sufficient to keep the magnetic particles suspended within the magnetic fluid film.

### BRIEF DESCRIPTION OF THE DRAWINGS

FIG. 1 is a simplified schematic top view of one configuration of an optical pick-up actuator.

FIG. 2 is a simplified cross-sectional view along A-A of the optical pick-up actuator illustrated in FIG. 1 with the volatile magnetic fluid in the magnetic gap.

FIG. 3 is a simplified cross-sectional view of an assembled optical pick-up actuator illustrated in FIG. 2 after the volatile magnetic fluid in the magnetic gap has been evaporated.

FIG. 4 a simplified schematic top view of another configuration of an optical pick-up actuator.

FIG. 5 is a simplified cross-sectional view along B-B of the optical pick-up actuator illustrated in FIG. 4 after the volatile magnetic fluid in the magnetic gap has been evaporated.

### DETAILED DESCRIPTION OF THE PREFERRED EMBODIMENT

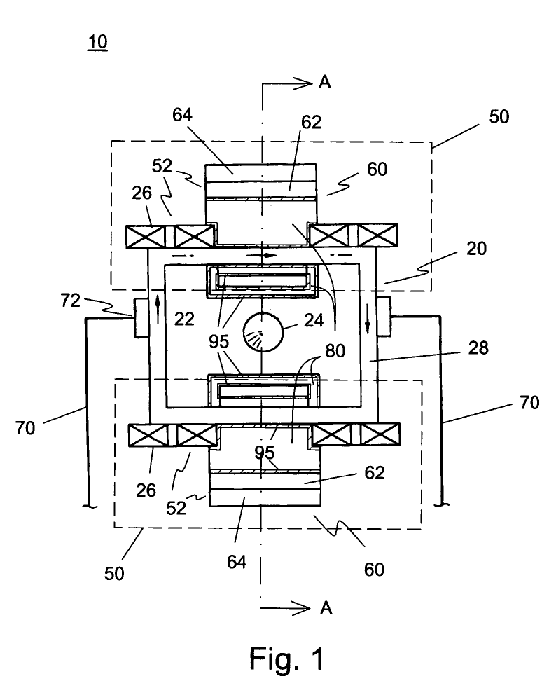

The preferred embodiment of the present invention is illustrated in FIGS. 1-5. It should be understood that the size and spacing between the components as illustrated are enlarged and are not to scale in order to make it easier to understand the structural relationships between the various components of the present invention.

Now turning to FIG. 1, there is shown a simplified, schematic top view of one embodiment of an optical pick-up actuator 10. Optical pick-up actuator 10 includes a lens holder assembly 20, a base unit (not shown), and an electro-magnetic drive system 50. Lens holder assembly 20 and the base unit have complementary electromagnetic components 52 of electromagnetic drive system 50. In this embodiment, the base unit's complementary electro-magnetic components are magnetic assembly 60. Lens holder assembly 20 includes a lens holder 22, an optical lens 24 supported by lens holder 22, and complementary electromagnetic components 52 that includes a tracking coil 26 placed at the exterior of lens holder 22 and a focusing coil 28 wound around the lens holder 22 so as to be at right angles to the tracking coil 26. Magnetic assembly 60 includes two magnets 62 respectively placed at the front and rear of lens holder assembly 20 and a yoke 64 placed at the rear of magnet 62 and preventing leakage of magnetic flux from the rear of magnet 62. It is noted that the complementary electro-magnetic components, i.e. focusing coil 28, tracking coil 26 and magnetic assembly 60, may be arranged such that the magnetic assembly 60 is part of the lens holder assembly 20 and the coils 26, 28 are part of the base unit or some combination that provides the focusing and tracking function required of optical pick-up actuator 10.

In FIG. 1, optical pick-up actuator 10 performs the focusing movement and the tracking movement by having the tracking coil 26 and the focusing coil 28 within a magnetic space or gap 80 formed with magnet 62 and yoke 64 and moving the optical lens 24 up-down and right-left by Lorentz force of Fleming's left-hand rule. Optical pick-up actuator 10 further includes resilient support members 70 and a printed circuit board (not shown) mechanically connected to a fixed component (not shown) of the base unit by having a fixation point 72 at the right and left sides of the lens holder assembly 22.

Tracking coil 26, focusing coil 28, magnets 62, and yokes 64 have a residual layer 95 on various surfaces caused by the evaporation of the volatile base carrier liquid of a volatile magnetic fluid used in the assembly of optical pick-up actuator 10. Residual layer 95 is composed of a plurality of magnetic particles of the volatile magnetic fluid left behind after evaporation.

The present invention provides a method for locating and positioning the lens holder assembly 22 relative to the magnetic assembly 60 creating a magnetic gap 80 during the assembly process. One embodiment of the method of the present invention includes the use of a volatile magnetic fluid. The volatile magnetic fluid generally comprises a volatile carrier liquid or base liquid, a plurality of magnetic particles, and a dispersant for dispersing the plurality of magnetic particles in the volatile carrier liquid. Some useful carrier liquids are water and aliphatic hydrocarbons such as hexane, heptane and octane. Any conventional magnetic fluid based on volatile liquids as the carrier liquid may be used and the formulations of such volatile magnetic fluids are within the knowledge of one of ordinary skill in the art. Although aromatic hydrocarbon and other polar solvents may be used as the base carrier liquid, it is hypothesized that use of these types of liquids may affect the integrity of adhesives used, if any, in the optical pick-up actuator 10.

The quantity of magnetic particles per unit volume of magnetic fluid is represented by the magnetic fluid's saturation magnetization and it is measured in Gauss (mT). A low saturation magnetization fluid tends to leave a thinner residual layer of magnetic particles than a magnetic fluid with a higher saturation magnetization. However, either one may be used depending on the manufacturing procedure used. Using a magnetic fluid with a low saturation magnetization allows for filling of the magnetic gap with the fluid for positioning the lens holder assembly 22.

Using a magnetic fluid with a higher saturation magnetization allows for incomplete filing of the magnetic gap such that the magnetic gap has air passages but provides a stronger magnetic centering force. Preferably, the saturation magnetization range for use in the present invention is kept reasonably low so as not to form a relatively thick residual layer of magnetic particles on focusing and tracking coils 26, 28 and/or magnets 62 and/or yokes 64. It should be understood that the proper saturation magnetization for a given volatile magnetic fluid composition will be dependent of a variety of factors including the type of carrier liquid used as the base volatile liquid in the volatile magnetic fluid, the size of the optical pick-up actuator, the size of the radial gap, etc.

To reduce the chance of any of the plurality of magnetic particles left behind as residue from dislodging from the coils 26, 28, the magnets 62 or yokes 64, a lubricating oil may optionally be added to the volatile magnetic fluid. The lubricating oil is of a type and quantity such that upon evaporation of the volatile carrier liquid, the remaining magnetic particles and lubricating oil would form a thin, oil-based magnetic fluid film or layer along the surfaces of the magnets, yokes and focusing/tracking coils. The lubricating oils useful in the present invention are oils such as hydrocarbon, ester, ether, perfluorocarbon, and silicone. The preferred oil is a hydrocarbon oil including petroleum and synthetic hydrocarbons. Among such hydrocarbons, aromatic hydrocarbons may be more reactive with other materials used in an optical pick-up actuator than aliphatic hydrocarbons. Parafinic, naphthenic and poly alpha olefin may be preferable. Poly alpha olefin is the most preferable for its characteristic low pour point, low viscosity, low volatility, and inertness. In addition, where poly alpha olefins used in conventional magnetic fluids for damping and heat transfer purposes have 6 cSt or higher viscosity at 100° C., it is preferable to use lower molecular weight poly alpha olefins (less than 6 cSt), preferably 4 cSt or lower. This is so because the high molecular weight poly alpha olefins need a second large dispersant on the magnetic particles to disperse the magnetic particles within the higher molecular weight poly alpha olefins. The higher molecular weight poly alpha olefins are less preferred because the second large dispersant generates a larger volume of residual particles, which leaves a thicker residual layer after evaporation of the volatile carrier liquid.

The residual magnetic fluid layer of the present invention that remains after evaporation of the volatile carrier liquid should be as thin as possible. Thus, the amount of lubricating oil in the solvent-based magnetic fluid should be no more than fifty volume percent (50 vol. %) of the total volume of the initial solvent-based magnetic fluid plus the lubricating oil. The smaller the volume percent of lubricating oil, the thinner the residual layer.

In another embodiment of the present invention, a low viscosity oil-based magnetic fluid is substituted for the volatile magnetic fluid. In this case, the low viscosity oil-base ferrofluid remains in the optical pick-up actuator 10 during its working life. Like the volatile magnetic fluid, the low viscosity oil-based magnetic fluid is used for positioning the lens holder assembly 20 relative to the magnets and yokes 62, 64. The use of low viscosity oil-based magnetic fluid has additional benefits including, for example, damping of vibration caused by focusing and tracking movement of the lens holder or by an outside shock, heat removal, etc. Heat removal from the coils can be done more effectively with the use of the low viscosity oil-based magnetic fluid than without the use of magnetic fluid. This is so because the magnetic fluid is six times more thermally conductive than air. Thus, the transfer of heat from the coils through the magnetic fluid to the magnet and/or yoke is more effective than through air in the magnetic gap of conventional optical pick-up actuators. Using a thermally conductive material for the base unit to which the magnets and yokes are fixed further enhances heat dissipation. The preferred low viscosity oil is an ester-based oil.

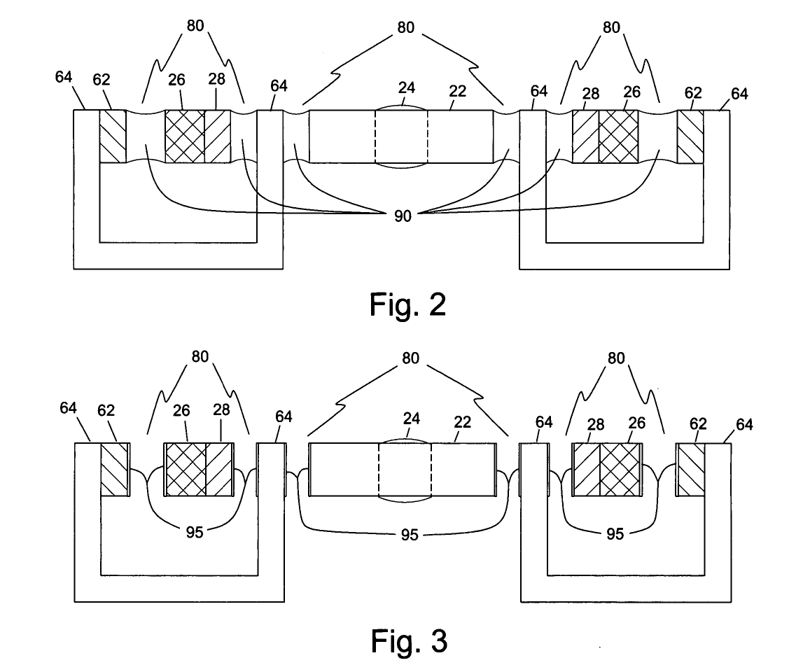

Turning now to FIGS. 2 and 3, there is shown the method of the present invention with an optical pick-up actuator illustrated in FIG. 1. It should be understood that the method can be use with most conventional pick-up actuators. FIG. 2 illustrates the cross-sectional view of the coil/magnet/yoke position in the pick-up actuator in FIG. 1. In this particular illustration, the base unit (not shown) includes magnetic assembly 60 formed by a support frame or yoke 64 and a magnet 62. The yoke 64 is U-shaped and has magnet 62 fixed to the inside of one of the legs of yoke 64. The other leg of the yoke 64 is positioned in an opening between focusing coil 28 and lens holder 22.

A predetermined amount of volatile magnetic fluid 90 is added to the magnetic gap 80. Magnetic fluid 90 may be added using a dispenser and then locating the dispenser close to magnetic gap 80 and transferring a predetermined amount of the volatile magnetic fluid to magnetic gap 80. It is noted that a properly sized capillary tube may be substituted for the needle rod. Volatile magnetic fluid 90, because of the magnetic force field established by magnet 62 with yoke 64, locates and positions lens holder 22 relative to the magnets and yokes 62, 64 in a evenly-spaced and magnetically balanced alignment to facilitate the proper positioning of the lens holder assembly 20 prior to securing the resilient support members 70. Lens holder assembly 20 is now fixed in position to the base unit (not shown).

After lens holder assembly 20 is fixed in position, volatile magnetic fluid 90 is evaporated from optical pick-up actuator 10 as shown in FIG. 3. Although the volatile base carrier liquid is evaporated, residual layer 95 is left behind on the surfaces of magnetic gap 80. In the preferred embodiment, residual layer 95 comprises the plurality of magnetic particles dispersed in the lubricating oil from the evaporated volatile magnetic fluid.

Where the low viscosity oil-based magnetic fluid of the present invention is chosen instead of the volatile magnetic fluid, the low viscosity oil-based magnetic fluid would remain within the magnetic gap 80 in a similar position as illustrated in FIG. 2.

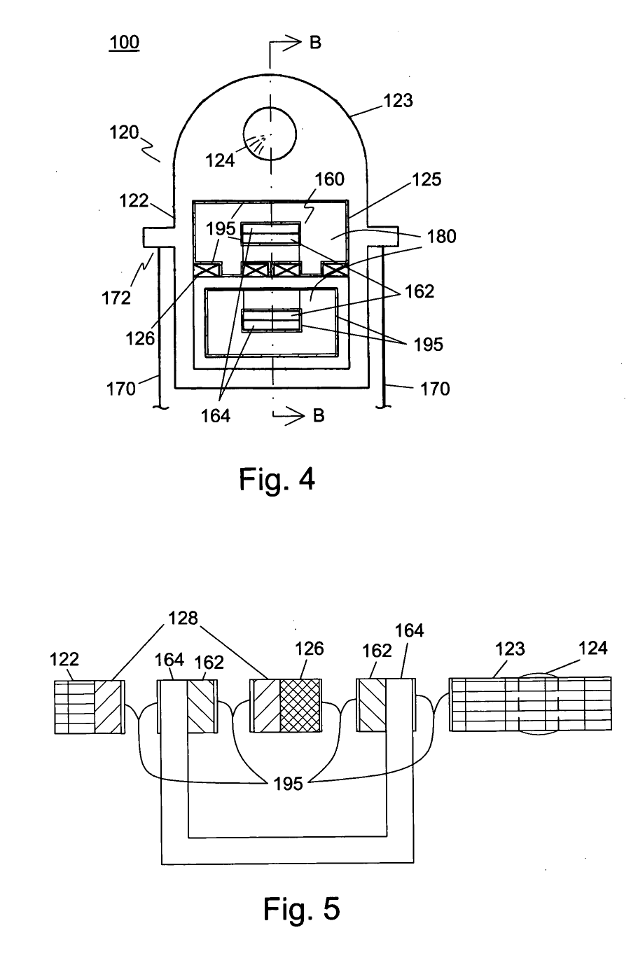

Turning now to FIG. 4, there is shown a simplified, schematic top view of another optical pick-up actuator 100 where the magnetic circuit is constructed so as to avoid the light path of the light source. Optical pick-up actuator 100 includes a lens holder assembly 120 and a magnetic assembly 160. Lens holder assembly 120 includes a lens holder 122, an optical lens 124 supported by lens holder 122 at a protrusion portion 123, a focusing coil 128 wound around a portion of the inside of a lens holder opening 125 of lens holder 122, and a tracking coil 126 installed within the lens holder opening 125 of lens holder 122 so as to be at right angles to the focusing coil 128. Magnetic assembly 160 includes two magnets 162 placed within lens holder opening 125 so that one magnet is situated within the opening defined by the focusing coil 128 and the other magnet is situated within the opening spaced from the tracking coil 126 and a yoke 164 placed at the rear of each magnet 162 and preventing leakage of magnetic flux from the rear of each magnet 162.

In FIG. 4, optical pick-up actuator 100 performs the focusing movement and the tracking movement by having the tracking coil 126 and the focusing coil 128 within a magnetic space or gap 180 formed with magnet 162 and yoke 164 and moving the optical lens 124 up-down and right-left. Optical pick-up actuator 100 further includes resilient support members 170 and a printed circuit board (not shown) mechanically connected to a fixed component (not shown) of the base unit by having a fixation point 172 at the right and left sides of the lens holder assembly 22.

Tracking coil 126, focusing coil 128, magnets 162, and yokes 164 have a residual layer 195 on various surfaces caused by the evaporation of the volatile base carrier liquid of a volatile magnetic fluid used in the assembly of optical pick-up actuator 100.

Turning now to FIG. 5, there is shown the method of the present invention with the optical pick-up actuator illustrated in FIG. 4. FIG. 5 illustrates the cross-sectional view of the coil/magnet/yoke position in the pick-up actuator in FIG. 4. In this particular illustration, the base unit (not shown) includes magnetic assembly 160 formed by a support frame or yoke 164 and a magnet 162. The yoke 164 is U-shaped and has magnet 162 fixed to the inside of each of the legs of yoke 164.

As discussed above, a predetermined amount of either the volatile magnetic fluid or the low viscosity oil-based magnetic fluid is added to the magnetic gap 180. Magnetic fluid 190, because of the magnetic force field established by magnet 162 with yoke 164, locates and positions lens holder 122 relative to the magnets and yoke 162, 164 in a evenly-spaced and magnetically balanced alignment to facilitate the proper positioning of the lens holder assembly 120 prior to securing the resilient support members 170. Lens holder assembly 120 is now fixed in position to the base unit (not shown).

It should be noted that the present invention can also be used with pick-up actuators where no yoke is included in the structural design of the actuator or in pick-up actuators where the magnetic assembly is configured to be a part of the lens holder assembly and the focusing and tracking coils are fixed to a base unit or a combination that provide a focusing and tracking movement of the lens holder.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A method of assembling a lens holder assembly to a base unit of a pick-up actuator wherein said lens holder assembly and said base unit each contain complementary electromagnetic components that together form an electro-magnetic drive system to control the focusing and tracking movement of said lens holder assembly relative to said base unit, said electro-magnetic components include a tracking coil, a focusing coil perpendicular to said tracking coil and a magnetic system wherein a magnetic gap is formed between said electro-magnetic components of said lens holder assembly and said electromagnetic components of said base unit when assembled, said method comprising:
assembling said lens holder assembly and said base unit to each other forming said magnetic gap;
disposing a predetermined amount of a volatile magnetic fluid containing a volatile base carrier liquid into said magnetic gap;
fixing resilient support members between said lens holder assembly and said base unit; and
evaporating said volatile base carrier liquid from said volatile magnetic fluid.

2. The method of claim 1 further comprising formulating said volatile magnetic fluid.

3. The method of claim 2 wherein said formulating step further includes obtaining a plurality of magnetic particles, suspending said plurality of magnetic particles in said volatile base carrier liquid, and adding a sufficient amount of dispersing agent to said volatile base carrier liquid to disperse said plurality of magnetic particles in said carrier liquid.

4. The method of claim 3 wherein said formulating step further includes adding a pre-determined amount of lubricating oil.

5. The method of claim 3 further comprising removing the excess dispersing agent from said carrier liquid.

6. The method of claim 4 wherein said step of adding said lubricating oil further includes adding a quantity of lubricating oil wherein said quantity is less than or equal to fifty volume percent of said volatile magnetic fluid.

7. The method of claim 4 wherein said step of adding said lubricating oil further includes adding one of a hydrocarbon, ester, ether, perfluorocarbon or silicone lubricating oil.

8. The method of claim 3 wherein said step of adding said lubricating oil further includes adding lubricating oil having a viscosity of less than six centistokes at 100° C.

9. A method of assembling a lens holder assembly to a base unit of a pick-up actuator wherein said lens holder assembly and said base unit each contain complementary electromagnetic components that together form an electro-magnetic drive system to control the focusing and tracking movement of said lens holder assembly relative to said base unit, said electro-magnetic components include a tracking coil, a focusing coil perpendicular to said tracking coil and a magnetic system wherein a magnetic gap is formed between said electromagnetic components of said lens holder assembly and said electro-magnetic components of said base unit when assembled, said method comprising:
assembling said lens holder assembly and said base unit to each other forming said magnetic gap;
disposing a predetermined amount of a low viscosity oil-based magnetic fluid having a viscosity of less than 1,000 cP at 27° C. into said magnetic gap; and
fixing resilient support members between said lens holder assembly and a base unit.

10. The method of claim 9 wherein said magnetic fluid has a viscosity of less than 500 cP at 27° C.

11. The method of claim 9 wherein said magnetic fluid has a viscosity of less than 300 cP at 27° C.

12. An optical pick-up actuator comprising:
a base unit;
a lens holder assembly; and
resilient support members connecting said lens holder assembly to said base unit wherein said lens holder assembly and said base unit each contain complementary electromagnetic components that together form an electromagnetic drive system to control the focusing and tracking movement of said lens holder assembly relative to said base unit, said electromagnetic components include a tracking coil, a focusing coil perpendicular to said tracking coil and a magnetic system wherein a magnetic gap is formed between said electromagnetic components of said lens holder assembly and said electromagnetic components of said base unit; and
a residual magnetic layer disposed on the surfaces of one or more of said electromagnetic drive system in the area of said magnetic gap, said residual magnetic layer comprising a plurality of magnetic particles.

13. The actuator of claim 11 wherein said residual magnetic layer is formed by the evaporation of a volatile base carrier liquid of a volatile magnetic fluid.

14. The actuator of claim 11 wherein said residual magnetic layer includes a plurality of magnetic particles dispersed in a lubricating oil.

15. The actuator of claim 13 wherein said residual magnetic layer is formed by the evaporation of a volatile base carrier liquid of a volatile magnetic fluid containing a pre-determined amount of lubricating oil.

16. The actuator of claim 13 wherein said lubricating oil has a viscosity of less than six centistokes at 100° C.

17. The actuator of claim 13 wherein said lubricating oil is one of a hydrocarbon, ester, ether, perfluorocarbon, or silicone oil.

18. The actuator of claim 13 wherein said residual magnetic fluid layer has a saturation magnetization of 1,000 Gauss or less.

19. The actuator of claim 12 wherein said magnetic system includes a magnet or a magnet and a yoke.

20. An optical pick-up actuator comprising:
a base unit;
a lens holder assembly; and
resilient support members connecting said lens holder assembly to said base unit wherein said lens holder assembly and said base unit each contain complementary electromagnetic components that together form an electro-magnetic drive system to control the focusing and tracking movement of said lens holder assembly relative to said base unit, said electromagnetic components include a tracking coil, a focusing coil perpendicular to said tracking coil and a magnetic system wherein a magnetic gap is formed between said electromagnetic components of said lens holder assembly and said electromagnetic components of said base unit; and
a low viscosity oil-based magnetic fluid disposed within said magnetic gap wherein said magnetic fluid has a viscosity of less than 1,000 cP at 27° C.

21. The optical pick-up actuator of claim 20 wherein said magnetic fluid has a viscosity of less than 500 cP at 27° C.

22. The optical pick-up actuator of claim 20 wherein said magnetic fluid has a viscosity of less than 300 cP at 27° C.

23. A pick-up actuator comprising:
a base unit;
a lens holder assembly; and
resilient support members connecting said lens holder assembly to said base unit wherein said lens holder assembly and said base unit each contain complementary electromagnetic components that together form an electro-magnetic drive system to control the focusing and tracking movement of said lens holder assembly relative to said base unit, said electro-magnetic components include a tracking coil, a focusing coil perpendicular to said tracking coil and a magnetic system wherein a magnetic gap is formed between said electro-magnetic components of said lens holder assembly and said electro-magnetic components of said base unit; and
a volatile magnetic fluid temporarily disposed in said magnetic gap, said volatile magnetic fluid having a volatile carrier liquid.

24. The actuator of claim 23 wherein said volatile magnetic fluid contains a pre-determined amount of lubricating oil.

25. The actuator of claim 23 wherein said volatile carrier liquid is one or more of water, aliphatic hydrocarbon, aromatic hydrocarbon, and other polar solvent.

26. The actuator of claim 25 wherein said aliphatic hydrocarbon is selected from the group consisting of hexane, heptane and octane.

27. The actuator of claim 24 wherein said volatile magnetic fluid containing said pre-determined amount of lubricating oil includes a volatile carrier liquid, a plurality of magnetic particles and a sufficient quantity of dispersing agent to disperse said plurality of magnetic particles in said volatile carrier liquid.

28. The actuator of claim 24 wherein said volatile magnetic fluid has a saturation magnetization sufficiently low to minimize the quantity of residual magnetic fluid containing said plurality of magnetic particles and said lubricating oil on the surfaces within said magnetic gap after removal of said volatile carrier liquid.

29. The actuator of claim 24 wherein said lubricating oil has a viscosity of less than six centistokes at 100° C. before adding said lubricating oil to said volatile magnetic fluid.

30. The actuator of claim 24 wherein said lubricating oil is one of a hydrocarbon, ester, ether, perfluorocarbon, or silicone oil.

31. The actuator of claim 24 wherein said lubricating oil has a concentration of fifty volume percent or less of said volatile magnetic fluid.
